(19) United States
(12) Patent Application Publication
(10) Pub. No.: US 2010/0072261 A1
(43) Pub. Date: Mar. 25, 2010

(54) FRICTION STIR WELDING SPINDLE DOWNFORCE AND OTHER CONTROL TECHNIQUES, SYSTEMS AND METHODS

(76) Inventors: Marcio Fernando Cruz, Sao Paulo (BR); Gustavo Froitas, Rio Grande do Sulf (BR); Hamilton Zanini, Sao Paulo (BR); Jefferson Adriano da Costa, Rio Grande de Sul (BR); Rooson Fernando de Oiveira Pereita, Sao Paulo (BR); Edson Pereira, Rio Grande de Sul (BR); Ferrando Ferrera Fernandez, Sao Paulo (BR); Mauricio Andena, Sao Paulo (BR)

Correspondence Address: NIXON & VANDERHYE, PC, 901 NORTH GLEBE ROAD, 11TH FLOOR, ARLINGTON, VA, 22203, US

(21) Appl. No.: 12/237,856

(22) Filed: Sep. 25, 2008

(51) Int. Cl. B23K 20/12; B23K 20/26

(52) U.S. Cl. 228/102; 228/2.1

(57) ABSTRACT

Friction stirred welding equipment, developed according to requirements of high reliability, robustness, precision and low cost, weld lap and butt joints in complex surfaces with fixed pin tool under controlled downforce. Exemplary equipment comprises a control force orbital spindle, wherein a coaxial sensor measures the downforce and simultaneously the axial electrical actuator corrects axial tool position along the welding, by a direct axial force system control, in order to maintain controlled downforce according to previously set parameters. The equipment sets up, monitors and controls the spindle rotation speed, welding speed, acceleration speed and downforce and can record in a database the downforce and tool welding position during the welding. The exemplary equipment may also comprise a laser system that scans the backing surface before welding and corrects original tool path, in order to provide an offset tool path and precision alarm system to get a safe welding, avoiding tool collision with the backing.

### CROSS-REFERENCES TO RELATED APPLICATIONS

Not Applicable

### STATEMENT REGARDING FEDERALLY SPONSORED RESEARCH OR DEVELOPMENT

Not Applicable

### FIELD

The technology herein generally relates to friction stir welding, and more specifically to a collection of techniques for controlling the force, axial position and other parameters of an orbital spindle used for friction stir welding. Still more specifically, the technology herein relates to an axial force system that monitors and controls the downforce of a friction stir welding orbital spindle by correcting axial tool position along the welding, e.g., according to numerical control parameters. The technology herein also includes a welding safety system that uses laser sensing to avoid tooling collision, and to other friction stir welding spindle control techniques.

### BACKGROUND AND SUMMARY

Most people think of welding as requiring a torch or arc that is hot enough to melt the materials being welded. However, a kind of welding called friction stir welding (FSW) is a solid-state joining process that can join materials without melting them. It is commonly used for applications where it is helpful that the original material characteristics remain largely unchanged. Friction stir welding can be used to weld aluminum, magnesium, copper, titanium, steel, and some plastics.

FIGS. 1, 1A, 1B and 1C show exemplary illustrative friction stir welding equipment. To accomplish friction stir welding, a specially designed rotating tool heats up and mixes the interface portions where two parts meet. This heating and mixing of the materials in solid state joins the parts without causing them to melt. The rotating tool is in the shape of a pin mounted on a rotating spindle. The tool has a shoulder that doesn't penetrate into the material to be welded, but rotates over it. This rotation generates friction and consequently thermal energy that softens the material to be welded.

As shown in FIGS. 1 and 1A-1C, the specially designed tool is typically cylindrical with shoulders, and has a profiled threaded/unthreaded wear-resistant probe (pin or nub) 18. The spindle 16 typically rotates the tool 18 at a constant speed and feeds the tool at a constant traverse rate. To join two pieces together, the tool 18 is inserted into a joint line between two pieces of sheet or plate material which are butted together. The parts are generally clamped rigidly onto a backing bar in a manner that prevents the abutting joint faces from being forced apart. The length of the pin 18 is generally slightly less than the weld depth required. The tool shoulder is in contact with the work surface, and the pin is then moved relative to the workpiece.

As the spindle 16 rotates pin 18, frictional heat is generated between the welding tool shoulder and pin and the material of the workpieces. This heat, along with the heat generated by the mechanical mixing process and the adiabatic heat within the material, causes the stirred materials to soften without reaching the melting point. The tool 18 traverses along the weld line. As the rotating pin 18 is moved in the direction of welding, the leading face of the pin, assisted by a special pin profile, forces plasticized material to the back of the pin while applying a substantial forging force to consolidate the weld material. The welding of the material is accomplished by plastic deformation and dynamic recrystallization in the solid state. The frictional stir welding equipment can be programmed to provide any of a variety of welding patterns for lap and butt joints in complex surfaces under electronic control (e.g., by a Numerical Control unit).

FSW provides a number of potential advantages over conventional fusion-welding processes such as for example:

Good mechanical properties of the welded workpiece without need to melt the workpieces;

Improved safety due to the absence of toxic fumes or the spatter of molten material;

Welding patterns are easily automated on relatively simple milling machines;

Can operate in all positions (horizontal, vertical, etc);

Generally good weld appearance and minimal thickness under/over-matching, thus reducing the need for expensive machining after welding;

Low environmental impact

Other.

During friction stir welding, a number of forces will act on the tool 18. For example, a downwards force is used to maintain the position of the tool 18 at or below the material surface. A traversal force acts parallel to the tool 18's motion. A lateral force may act perpendicular to the tool traverse direction. A torque is used to rotate the tool 18. How much torque is used will depend on the downforce and the friction coefficient (sliding friction) and/or the flow strength of the material in the surrounding region (sticking friction).

In many cases, the vertical position of the tool 18 is preset and so the load will vary during welding. However, friction stir welding machines that automatically control some or all of these various forces to provide constant downforce provide certain advantages. In this case, the FIG. 1, 1A friction stir welding equipment includes actuators and sensors that are able to automatically control the position, orientation and motion of the pin 18. Some friction stir welding systems include various sensors such as load cells, pressure sensors and displacement sensors that sense the position of the tool 18 and the amount of force the tool is applying. A control system can be used to control tool position and downforce in response to these sensed parameters.

In order to prevent tool fracture and to minimize excessive tool wear, it is generally desirable to control the welding operation so that the forces acting on the tool are as low as possible and sudden changes are avoided. Conditions that favor low forces (e.g. high heat input, low travel speeds) may however be undesirable from the point of view of productivity and weld properties. While constant downforce is a desirable design goal, because of the many factors involved it can be difficult to achieve. Complete safety from the tool colliding with the backing surface is often not possible due to slight warpage or other distance variations of the backing relative to the tool.

While much work concerning automatic control of friction stir welding equipment has been done in the past, further improvements and developments are possible and desirable.

The technology herein provides friction spin welding equipment and methods, developed according to requirements of high reliability, robustness, precision and low cost, in order to weld lap and butt joints in complex surfaces with fixed or substantially constant pin tool control force.

Exemplary illustrative non-limiting equipment comprises a control force orbital spindle. A coaxial sensor measures downforce. Simultaneously, an axial electrical actuator is controlled to correct the axial tool position along the welding, by a direct axial force system control, in order to maintain controlled downforce according to parameters previously set, based on numerical control. The equipment also sets up, monitors and controls spindle rotation speed, welding speed, acceleration speed and downforce using for example closed loop control functions. The exemplary illustrative non-limiting implementation may also record in a database the downforce and tool welding position during welding.

In addition, exemplary illustrative non-limiting equipment comprises a laser system that scans the backing surface before welding and corrects original tool path, in order to get an offset tool path. A precision alarm system provides safe welding while preventing the tool from colliding with the backing.

A method of performing friction stirred welding comprises:

(a) measuring the downforce that a rotating friction stirred welding tool applies to a workpiece; and

(b) controlling an electrically controlled actuator based on numeric control while correcting axial tool position at least in part in response to said measured downforce to thereby maintain the load between tolerance limits, said controlling including avoiding oscillations of the load applied to the workpiece by applying proportional integral derivative control to maintain the load constant or substantially constant during welding.

The method can further include measuring variations in axial distance between the tool and the workpiece. The method can further include measuring variations in axial distance between a spindle into which the tool is mounted and a backing onto which the workpiece is placed, and using said measured variations to correct axial tool position and avoid collision between said tool and the backing. The method can further include generating an alarm if the axial distance between the tool and the backing is less than a predetermined threshold distance determined based at least in part on said measured variations. The method can further include logging welding parameters during welding. The method can further include controlling rate of rotation of said tool using a closed loop control process.

The exemplary illustrative technology herein further provides a friction stirred welding system of the type including a spindle having a rotating tool mounted therein, said tool rotating in contact with a workpiece, the axial position of said tool being determined by an electrically controlled actuator. The system may comprise a sensor that measures the downforce the rotating tool applies to said workpiece. The system may further comprise a control system coupled to said sensor, said control system being structured to control said electrically controlled actuator to correct axial tool position at least in part in response to said measured downforce to thereby maintain the load between tolerance limits, said control system being further structured to avoid oscillations of the load applied to the workpiece by applying proportional integral derivative control to maintain the load constant or substantially constant during welding.

The system may further include a laser sensor that measures variations in axial distance between the tool and the workpiece.

The system may further include a laser sensor that is structured to measure variations in axial distance between the spindle into which the tool is mounted and a backing onto which the workpiece is placed, and said control system uses said measured variations to correct axial tool position and avoid collision between said tool and the backing.

The system may further include including an alarm that indicates if the axial distance between the tool and the backing is less than a predetermined threshold distance determined based at least in part on said measured variations.

The system may further include a data logger that logs welding parameters during welding.

The system may further include a closed loop control arrangement that controls rate of rotation of said tool.

The exemplary illustrative non-limiting technology herein further provides a method of performing friction stirred welding comprising: (a) inserting a sensor into a friction stirred welding spindle; (b) using the sensor to map the axial distance the friction stirred welding spindle is disposed from a backing surface; (c) removing said sensor from said spindle and inserting a tool in its place; (d) rotating said tool; (e) moving said rotating tool into contact with a workpiece placed on said backing surface; and (f) using said map to control an electrically controlled actuator to correct axial tool position relative to said workpiece, wherein said rotating tool in contact with said workpiece plasticizes portions of said workpiece while keeping said workpiece in the solid state, thereby welding said workpiece.

The method may further avoid oscillations of the load applied to the workpiece by applying proportional integral derivative control to maintain downforce of said tool constant or substantially constant during welding.

The method may measure variations in axial distance between a spindle into which the tool is mounted and a backing onto which the workpiece is placed, and using said measured variations to correct axial tool position and avoid collision between said tool and the backing.

The method may generate an alarm if the axial distance between the tool and the backing is less than a predetermined threshold distance determined based at least in part on said measured variations.

The method may automatically log welding parameters during welding.

The method may control rate of rotation of said tool using a closed loop control process.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 shows exemplary illustrative non-limiting friction stir welding equipment;

FIG. 1A is a more detailed view of the spindle portion of the FIG. 1 exemplary illustrative non-limiting friction stir welding equipment;

FIGS. 1B and 1C show an exemplary illustrative non-limiting friction stir welding spindle;

FIG. 2 shows an overall exemplary illustrative non-limiting electronic control system block diagram;

FIG. 2A shows an exemplary illustrative non-limiting machine control algorithm and process;

FIG. 3 shows an exemplary illustrative non-limiting portion of the FIG. 2 control system including spindle control components;

FIG. 4 shows an exemplary illustrative spindle downforce control system;

FIG. 5 shows an exemplary illustrative spindle downforce control system using a laser sensor to sense variations in distance to a backing surface;

FIG. 6 illustrates an exemplary illustrative technique for using a laser sensor to sense actual distance to the backing;

FIG. 7 shows the FIG. 5 implementation using the distance the laser sensor sensed to establish a distance alarm threshold;

FIG. 8 shows an exemplary illustrative non-limiting prior art technique for controlling tool minimum distance to backing that sometimes caused collisions;

FIG. 9 shows a further exemplary illustrative non-limiting technique for controlling tool minimum distance to backing through use of laser sensing of actual distance to the backing, thereby avoiding collisions;

FIG. 10 shows an exemplary illustrative non-limiting alarm generation technique; and

FIG. 11 shows an exemplary illustrative non-limiting closed loop feedback control technique for controlling friction stir welding rotation.

### DETAILED DESCRIPTION

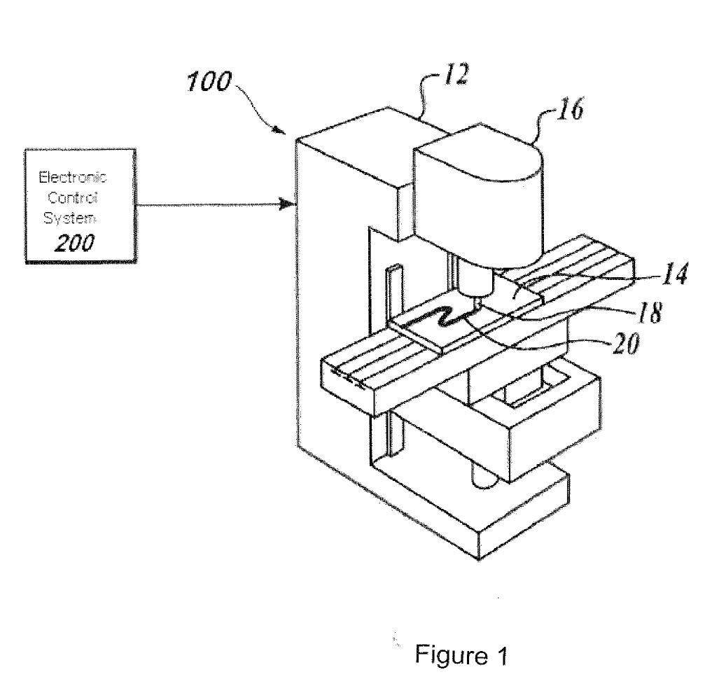

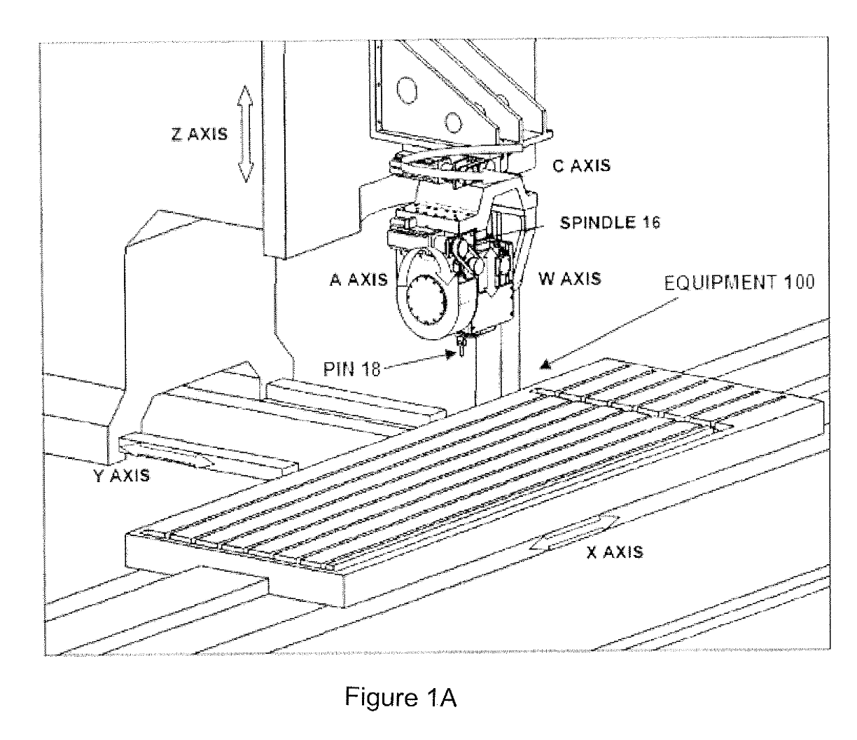

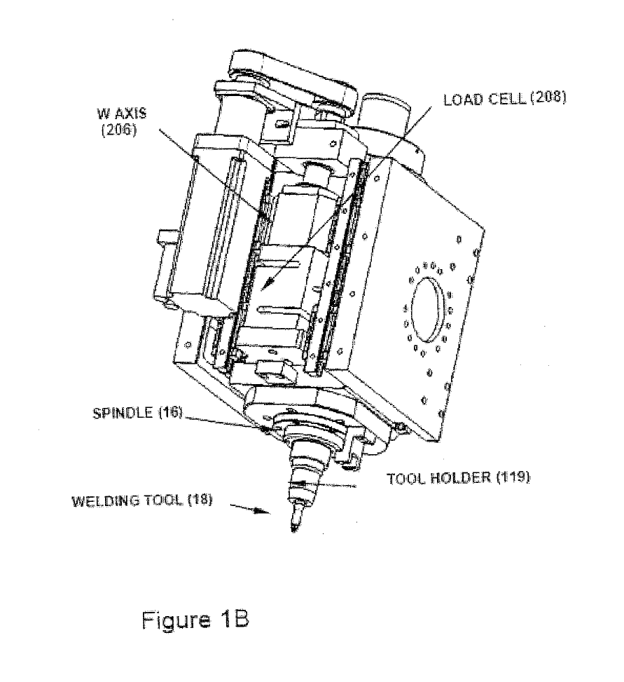

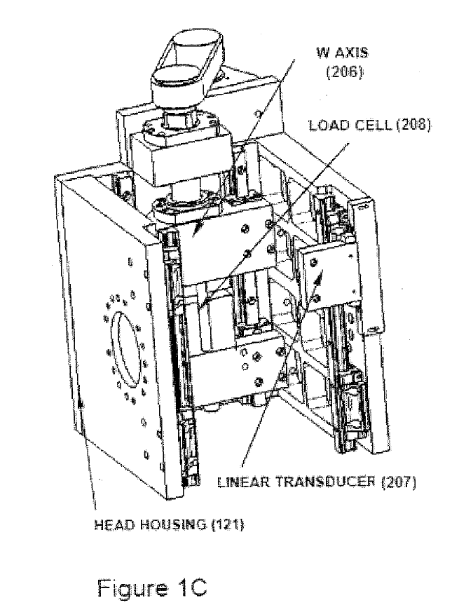

FIG. 1 is a side perspective view of exemplary illustrative non-limiting friction stir welding (FSW) equipment 100. Equipment 100 includes a frame 12 that moveably suspends a spindle 16 above a backing holding a workpiece 14. A rotating pin 18 replaceably installed in the spindle (this rotating pin is sometimes herein referred to as “the tool”) rotates in contact with the workpiece 14. By rotating in contact with the workpiece 14 with a desired amount of downforce, the rotating pin 18 accomplishes friction spin welding of the workpiece thereby for example welding two separate abutting pieces together along a weld line 20,

An electronic control system 200 controls the operation of equipment 100. In the exemplary illustrative non-limiting implementation, equipment 100 includes spindle 16 mounted in such a way that it can be controllable moved and positioned relative to the workpiece 14 clamped to or otherwise supported by the backing. The workpiece 14 typically comprises two pieces that are clamped to the backing so as to abut one another. The equipment 100 automatically controls the spindle 16's position and orientation as well as the rate of rotation of the welding pin 18 mounted therein in order to accomplish friction stir welding under controlled conditions.

As shown in FIG. 1A, the equipment 100 can control the translational and rotational position and orientation of the pin 18 relative to the backing in six degrees of freedom. For example, the equipment 100 can translate the backing back and forth (along the x axis) relative to the pin 18. Equipment 100 can also translate the pin 18 in two additional axes (y axis and z axis) relative to the backing, and the spindle 16 can rotate the pin 18 about all three rotational axes (pitch axis A, yaw axis w, and roll axis C). Such freedom of motion provides a high degree of controllability. In addition, spindle 16 can control the amount of downforce the pin 18 exerts onto the workpiece.

FIGS. 1B and 1C show additional details of electromechanical control actuators provided within the spindle 16 for accomplishing controlled motion and positioning of the pin 18 relative to the workpiece in six degrees of freedom, and further shows details of load cells that can be used to dynamically sense downforce. Note that the term “downforce” is not limited to the amount of force the spindle 16 or pin 18 applies downward in the vertical direction (i.e., toward the center of the earth) but can encompass force the tool applies toward the workpiece no matter what orientation the tool and workpiece assume relative to the horizon.

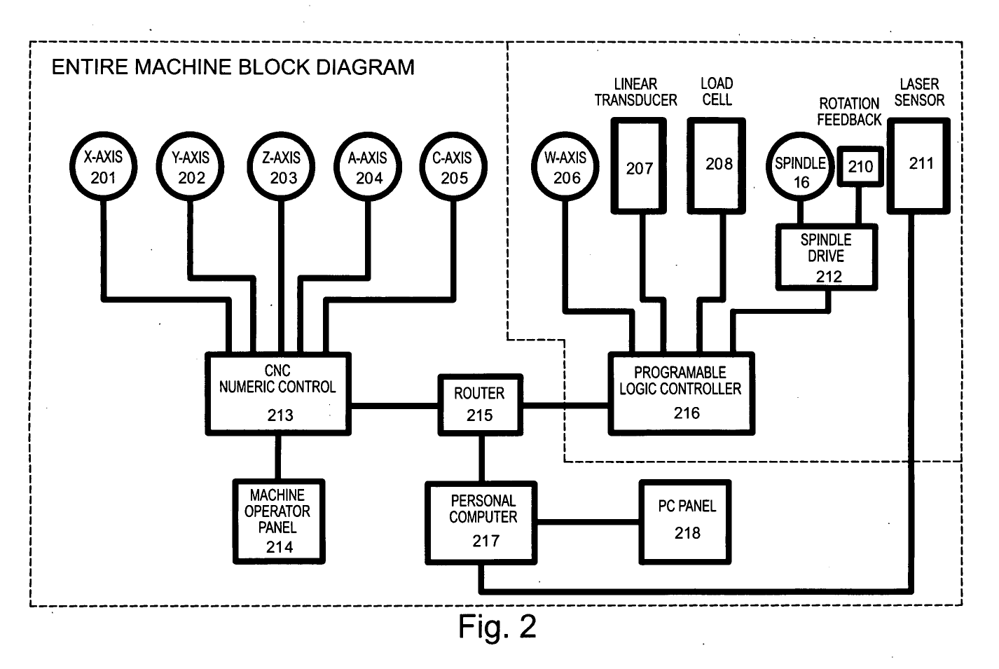

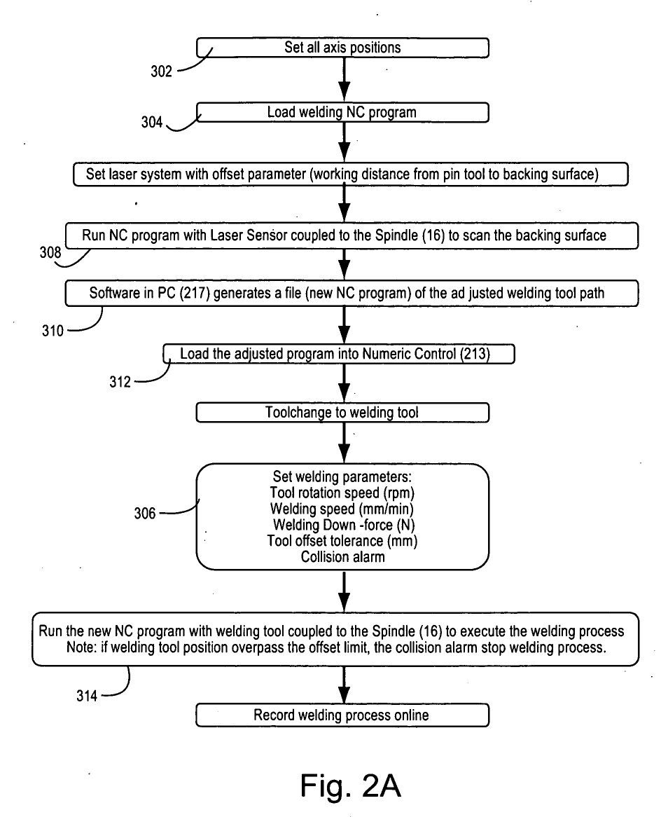

FIG. 2 is a schematic illustration of an exemplary illustrative non-limiting electronic control system 200. Non-limiting control system 200 includes a CNC numeric control 213, a machine operator panel 214, a router 215, a programmable logic controller 216, a personal computer 217, and a PC panel 218. CNC numeric controller 213 controls actuators which position and move the spindle 16 in three axes of translation and two axes of rotation. Programmable logic controller 216 controls an actuator for the spindle 16's third axis of rotation, and also receives inputs from linear transducer 207 and load cell 208. Spindle 16 is controlled by a spindle drive 212 at least in part in response to rotational feedback sensor 210. A laser sensor 211 may be used to accurately sense position of the tool relative to the workpiece. Personal computer 217 or other suitable processor coordinates the operation of numeric controller 218 and programmable logic controller 213 in response to user inputs from machine operator panel 214 and PC panel 218.

The Numeric Control 213 is responsible to provide precision control of five axis (201, 202, 203, 204, 205) and send information of their position to the Personal Computer 217 and PLC 216 through the Router 215. Machine Operator Panel 214 is used to operate all the functions of the machine. The load control and laser scanning is operated using the PC Panel 218 as an interface for a viewer.

As shown in FIG. 2A, an exemplary algorithm or process for operating equipment 100 comprises:
Execute homing command to set all the positions of the five axes (block 302)
Load the NC program of the welding tool path into Numeric Control 213 (block 304)
Set up the welding process parameters (block 306)
Run the program with Laser Sensor coupled to the Spindle 16 to scan the backing surface (block 308)
The software in PC 217 generates a file (new NC program) of the adjusted welding tool path (block 310)
Load the adjusted program into Numeric Control 213 (block 312)
Run the new NC program with welding tool coupled to the Spindle 16 to execute the welding process (block 314)

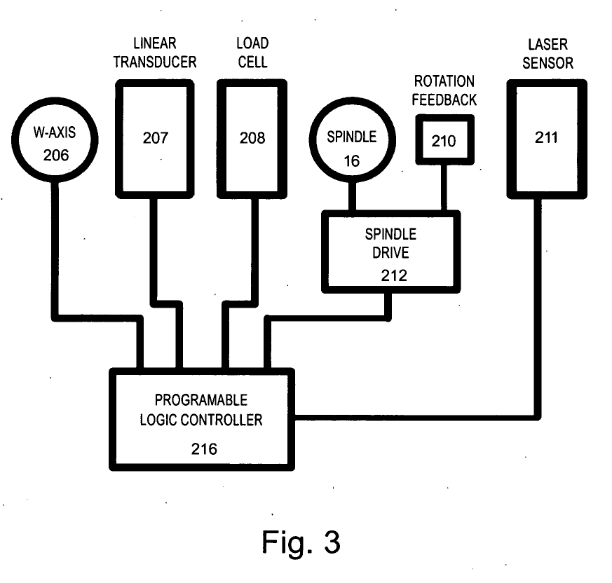

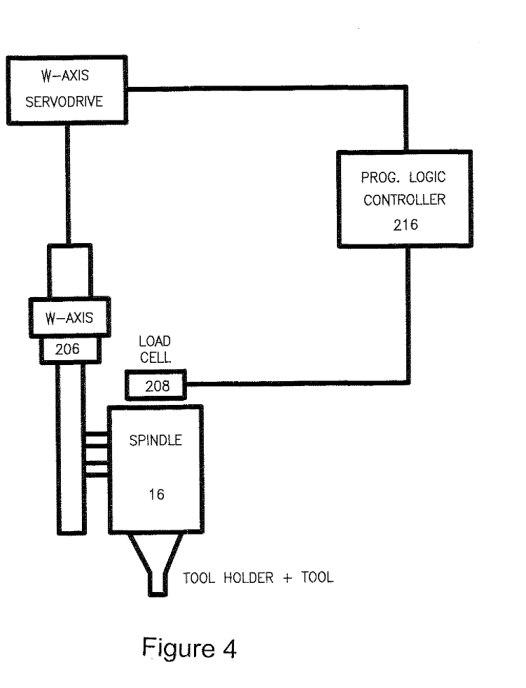

FIGS. 3 and 4 show exemplary spindle and load control provided by the programmable logic controller 216. The welding process on exemplary illustrative non-limiting machine 100 works according to a load control process. The exemplary load control is responsive to a load cell 208 that measures the direct axial downforce applied to the workpiece. It is also responsive to a precision position measure system provided by a linear transducer 207.

The exemplary illustrative non-limiting Programmable Controller 216 receives the following signals which it uses to provide precision control of the process:
W axis position;
Downforce value;
Status of Numeric Control (alarms and faults).

The exemplary illustrative non-limiting system monitors and controls the following items:
Downforce applied to workpiece during weld;
Distance from welding tool to the backing;
Spindle rotation speed.

The Numeric Control 213 receives the following information from Programmable controller 216:
Status of the system (alarms and faults)
Process welding parameters values.

The exemplary illustrative non-limiting system 100 works by controlling the downforce applied to the workpiece and simultaneously monitoring the distance from pin tool to the backing to avoid collisions.

In more detail, the W-Axis actuator 206 is responsible to move the spindle motor inside the Head housing 121. The linear transducer 207 is responsible to send the information of W axis position to the PLC 216 to keep the tool a safe distance (i.e, at least minimum clearance) from the backing during welding. Load Cell 208 directly measures the pressure applied to the workpiece during welding in the W axis. Spindle 16 provides the rotation to the tool 18. Rotation feedback sensor 210 measures rotation of the spindle 16 and sends it to the Spindle drive 212 to keep it in a fixed (constant or substantially constant) rotation during welding.

Laser Sensor 211 scans the welding backing and sends the information to the PC 217 to adjust the tool path in the welding NC (numerical control) program. Spindle drive 212 controls the rotation of the tool. Programmable Logic Controller 216 controls all the logic of the system include the downforce control and security of the distance from tool to backing to avoid collisions.

Exemplary Illustrative Non-Limiting Welding Downforce Control

The exemplary illustrative non-limiting implementation provides downforce control by measuring directly the load applied on the workpiece during all processes (see FIG. 4). There are three parameters for this control in the exemplary illustrative non-limiting implementation; all of them are previously set or predetermined before starting the welding process. The three parameters are:

1—Downforce into workpiece (set-point load);

2—Downforce work tolerance (range of work);

3—Downforce collision limit (to protect the machine and backing).

The exemplary illustrative non-limiting system 100 provides a precision closed loop control where the PLC 216 acts directly in the W-axis Servo Drive to maintain the load between tolerance limits (referred to a set-point load) during all welding. To avoid oscillations of the load applied to the workpiece, the control comprises with a PID (proportional integral derivative) control which maintains the load constant during the welding process.

Exemplary Illustrative Non-Limiting Scanning of the Welding Backing Surface

To start the scanning process, the Laser Sensor 211 is coupled to the Spindle 16 with the respective tool holder. After scanning, the laser sensor 211 may be removed and the welding tool 18 is installed in the tool holder in its place to start the welding process.

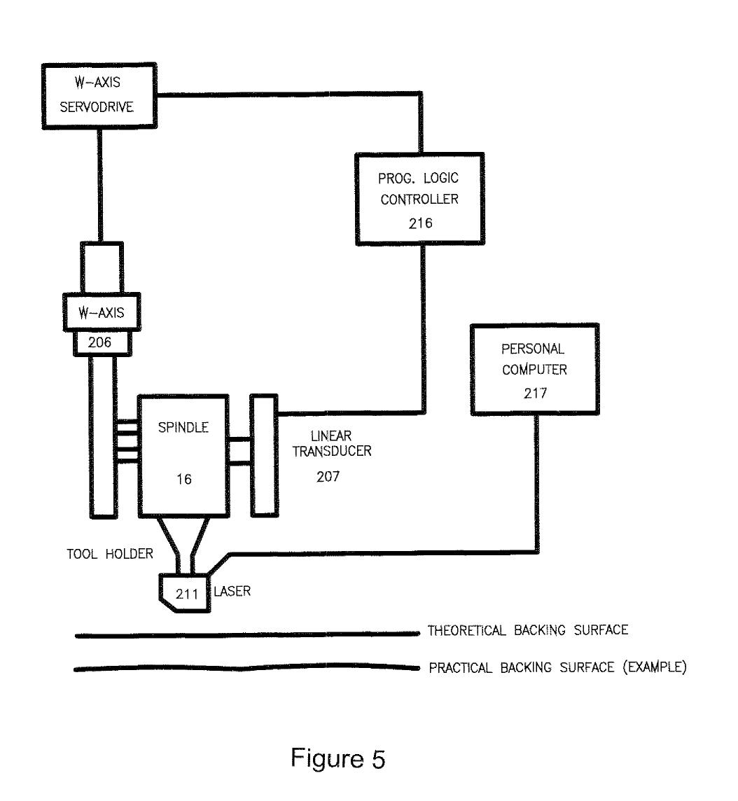

The scanning is used to adjust any deviation of the backing surface compared with the theoretical surface where the workpiece is placed (see FIG. 5). A parameter set according to process features represents the working distance from the pin tool 18 to the backing. In the exemplary illustrative non-limiting implementation, the alarm system responds directly to this adjustment. The adjustment provided by the scanning of laser sensor 211 thus provides working accuracy for the alarm.

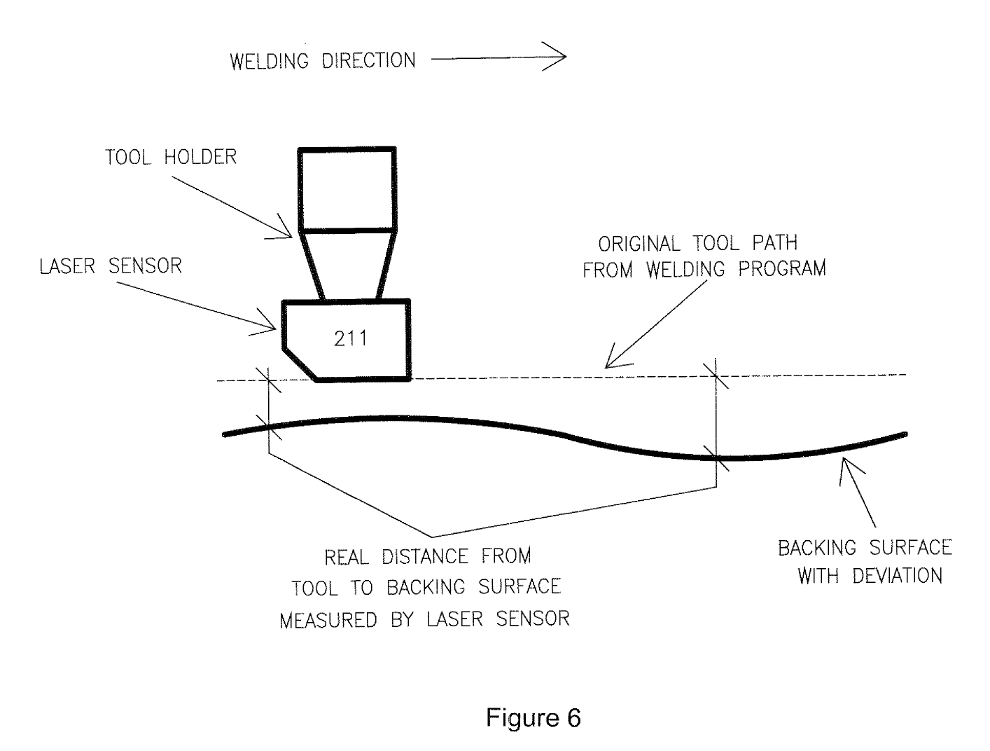

The exemplary illustrative non-limiting scanning process involves running the welding program with a laser sensor 211 coupled in the spindle as shown in the FIG. 6. When the program is running, the measuring data from the laser system records simultaneously in the PC 217. After the program is finished, the software in the PC generates a file of the adjusted welding tool path. The adjusted program is used in the machine to start the welding process.

Exemplary Illustrative Non-Limiting Distance Monitoring For Alarm System

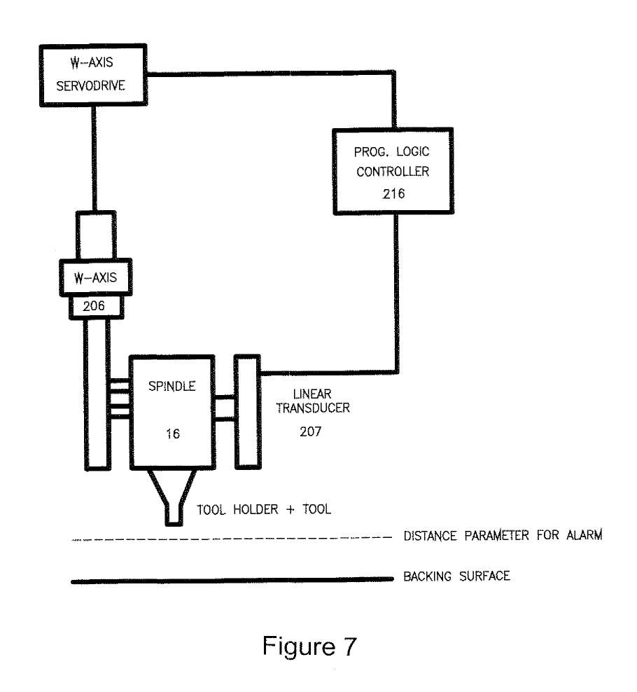

The exemplary illustrative non-limiting system 100 provides precision monitoring using linear transducer 207 and PLC 216 (see FIG. 7). The security of the backing provides a precise alarm system that works to protect the backing against collisions with the pin tool during the automatic welding process. This system works with high accuracy after the scanning of the backing surface. When the machine is working, the system 100 follows the NC (Numeric Control) program adjusted and simultaneously monitors the minimum distance from tool to backing (distance parameter for alarm system).

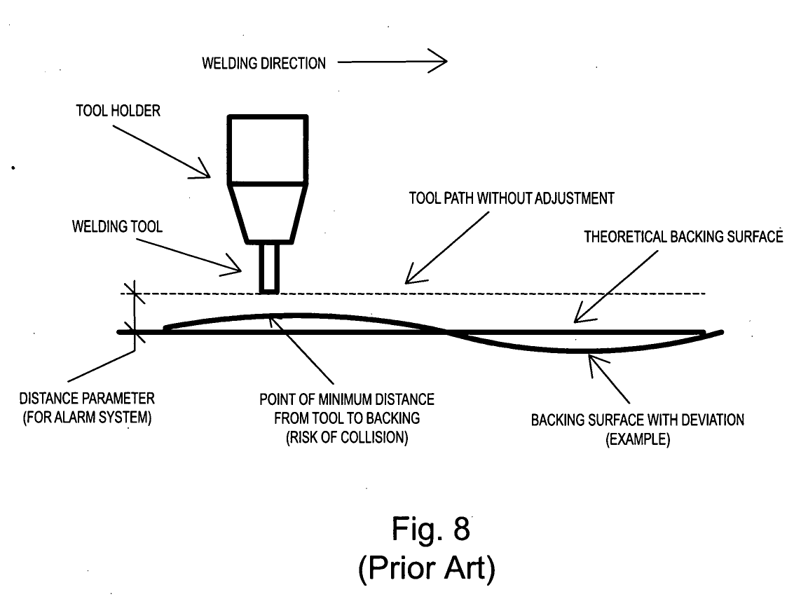

FIG. 8 shows an exemplary illustrative non-limiting prior art welding process without a laser scanning step previously performed. In this situation, the system understands or assumes the backing surface is a line or flat plane without deviations. Thus, considering that the tool path is not adjusted, risks of collision may occur at the points where the tool passes with a minimum distance from the backing.

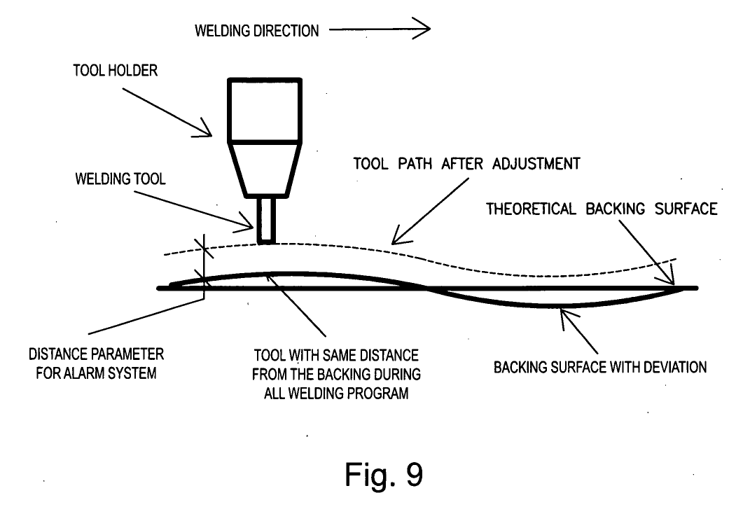

FIG. 9 illustrates the welding process after system 100 has performed the scanning step. Scanning with the laser sensor provides a kind of map of the backing. Such map could include three dimensional features of the backing for example. After scanning of the backing surface, the tool path is adjusted and the distance monitoring for the alarm system will work with high accuracy to avoid collisions between the pin tool and the backing. There is a parameter (distance parameter for alarm) set on the Operator Panel 214 that refers to the minimum distance from the tool to the backing. This parameter is adjusted according with workpiece thickness, process and tool features in the exemplary illustrative non-limiting implementation.

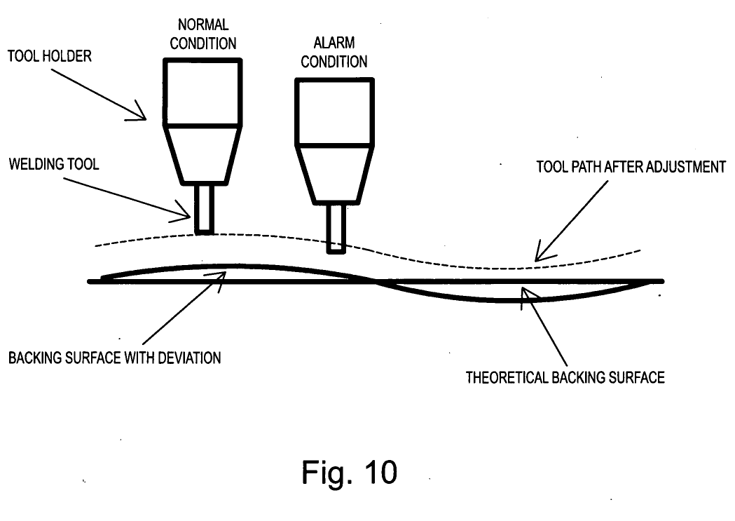

FIG. 10 shows an exemplary illustrative non-limiting welding process alarm system operation. When the program starts, the system 100 also starts monitoring this distance parameter measured by the Linear Transducer 207. If the tool activates a set-point distance for triggering an alarm, the execution of the program stops, all positional and orientation axes are maintain in a stopped or frozen state, the PLC 216 commands the W-axis servo drive to take the W-axis out of the workpiece, and an alarm is shown in the Operator Panel 214.

The welding parameters of downforce and W axis position are recorded by Personal Computer 217 in real time during the welding process in order to register and analyze the welding performance.

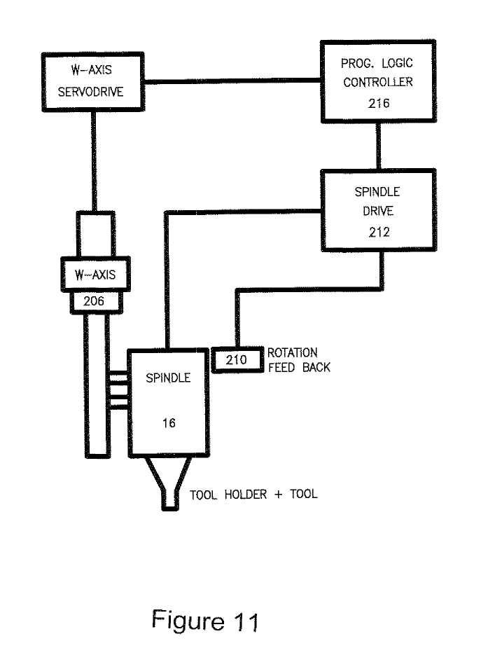

The system has a rotation control for the Spindle 16 provided by a Rotation Feed back 210. The rotation feed back is performed using a pulse sensor. The signal feed back is sent to the Spindle Drive 212 closing a control loop to maintain constant velocity (FIG. 11). This closed loop feedback is used to keep the tool rotation constant during the welding process.

While the technology herein has been described in connection with exemplary illustrative non-limiting implementations, the invention is not to be limited by the disclosure. The invention is intended to be defined by the claims and to cover all corresponding and equivalent arrangements whether or not specifically disclosed herein.

1-6. (canceled)

7. A friction stirred welding system of the type including a backing and a spindle adapted to accept a rotating tool mounted therein, said tool rotating in contact with a workpiece, the axial position of said tool being determined by an electrically controlled actuator, said system comprising:
a sensor that measures the downforce the rotating tool applies to said workpiece;
a control system coupled to said sensor, said control system being structured to control said electrically controlled actuator to correct axial tool position at least in part in response to said measured downforce to thereby maintain the load between tolerance limits, said control system being further structured to avoid oscillations of the load applied to the workpiece by applying proportional integral derivative control to maintain the load constant or substantially constant during welding, said control system including a closed-loop control arrangement that controls rate of rotation of the tool;
a laser sensor that is adapted to be accepted by the spindle and interchangeable with said rotating tool, said laser sensor mapping the axial distance between the spindle and the backing;
an alarm coupled to the laser sensor, said alarm indicating if the axial distance between the tool and the backing is less than a predetermined threshold distance determined based at least in part on measured variations; and
a data logger that logs welding parameters during welding.

8. (canceled)

9. The system of claim 7 wherein said laser sensor is structured to measure variations in axial distance between the spindle into which the tool is mounted and the backing onto which the workpiece is placed, and said control system uses said measured variations to correct axial tool position and avoid collision between said tool and the backing.

10-18. (canceled)
